(19) United States
(12) Patent Application Publication
(10) Pub. No.: US 2016/0011947 A1
(43) Pub. Date: Jan. 14, 2016

(54) RESISTANCE CHANGE MEMORY DEVICE

(71) Applicant: KABUSHIKI KAISHA TOSHIBA, Tokyo (JP)

(72) Inventor: Kosuke HATSUDA, Tokyo (JP)

(73) Assignee: KABUSHIKI KAISHA TOSHIBA, Tokyo (JP)

(21) Appl. No.: 14/476,368

(22) Filed: Sep. 3, 2014

Related U.S. Application Data
(60) Provisional application No. 62/022,536, filed on Jul. 9, 2014.

(51) Int. Cl. G06F 11/14

(52) U.S. Cl. CPC G06F 11/1469; G06F 11/1451; G06F 2201/84

(57) ABSTRACT

According to an embodiment, a resistance change memory device includes memory cells each including a resistance change element, reference cells each including a resistance change element, and a control circuit configured to control the memory cells and the reference cells, wherein, if an error is detected about data of a memory cell, the control circuit performs write back to data of the memory cell associated with the error detected and data of a reference cell in parallel with one another.

### CROSS REFERENCE TO RELATED APPLICATIONS

This application claims the benefit of U.S. Provisional Application No. 62/022,536, filed Jul. 9, 2014, the entire contents of which are incorporated herein by reference.

### FIELD

Embodiments described herein relate generally to a resistance change memory device.

### BACKGROUND

A resistance change memory device employs resistance change elements. Resistance change memory devices are required to be reliable in data writing and in data reading.

### BRIEF DESCRIPTION OF THE DRAWINGS

FIG. 1 shows an example of a circuit configuration of a resistance change memory device according to an embodiment;

FIG. 2 schematically shows an example of a memory element included in the resistance change memory device according to the embodiment;

FIG. 3A shows a write operation of the resistance change memory device according to the embodiment;

FIG. 3B shows a read operation of the resistance change memory device according to the embodiment;

FIG. 4A shows a write back operation of the resistance change memory device according to the embodiment;

FIG. 4B shows a write back operation of the resistance change memory device according to the embodiment;

FIG. 5A shows an example of the value of a current flowing through the resistance change memory device according to the embodiment;

FIG. 5B shows an example of the value of a current flowing through the resistance change memory device according to the embodiment;

FIG. 6A shows an example of the value of a current flowing through the resistance change memory device according to the embodiment;

FIG. 6B shows an example of the value of a current flowing through the resistance change memory device according to the embodiment;

FIG. 7A shows a write back operation of a resistance change memory device according to a modification of the embodiment;

FIG. 7B shows a write back operation of the resistance change memory device according to the modification of the embodiment;

FIG. 8A shows an example of the value of a current flowing through the resistance change memory device according to the modification of the embodiment;

FIG. 8B shows an example of the value of a current flowing through the resistance change memory device according to the modification of the embodiment;

FIG. 9A shows an example of the value of a current flowing through the resistance change memory device according to the modification of the embodiment; and

FIG. 9B shows an example of the value of a current flowing through the resistance change memory device according to the modification of the embodiment.

### DETAILED DESCRIPTION

A resistance change memory device employs resistance change elements or the like as memory cells. The resistance change elements hold different data by taking different resistance states. Specifically, for example, depending on the difference in the resistance states of the respective memory cells, the electric current values of the memory cells are changed relative to the electric current values of reference cells each serving as a data discrimination reference. Consequently, it is possible to discriminate data held in the memory cells.

When data is read from a memory cell, there may be a case where the data held in the target memory cell is determined as being incorrect (erroneous). In this case, for example, re-writing with correct data (write back) is performed to the memory cell. However, even if error correction is suitably repeated to memory cells, there may still be a case where the number of memory cells determined as being erroneous and/or the number of memory cells determined as being faulty increases with time.

According to embodiments described below, it is possible to reduce the memory cell failure rate. Specifically, a resistance change memory device according to embodiments comprises memory cells each including a resistance change element, reference cells each including a resistance change element, and a control circuit configured to control the memory cells and the reference cells. If an error is detected about a memory cell, the control circuit performs write back to data of the memory cell associated with the error detected and data of a reference cell in parallel with one another.

Now, embodiments will be explained with reference to the accompanying drawings. In the drawings, the same portions are denoted by the same reference symbols. Further, repetitive descriptions will be made as needed.

In the following explanation, when the term “connection” is simply referred to, it means physical connection, which encompasses direct connection and indirect connection through another element. When the term “electric connection” is referred to, it means an electrically conductive state, which encompasses direct connection and indirect connection through another element.

### One Embodiment

Hereinafter, a resistance change memory device according to this embodiment will be explained. For example, a resistance change memory device according to this embodiment is a magnetic memory device, such as an MRAM (Magnetoresistive Random Access Memory) of the STT (Spin-Transfer Torque) type. For example, the STT-MRAM employs a magnetoresistive element as a resistance change element.

(1) Configuration Example of Resistance Change Memory Device:

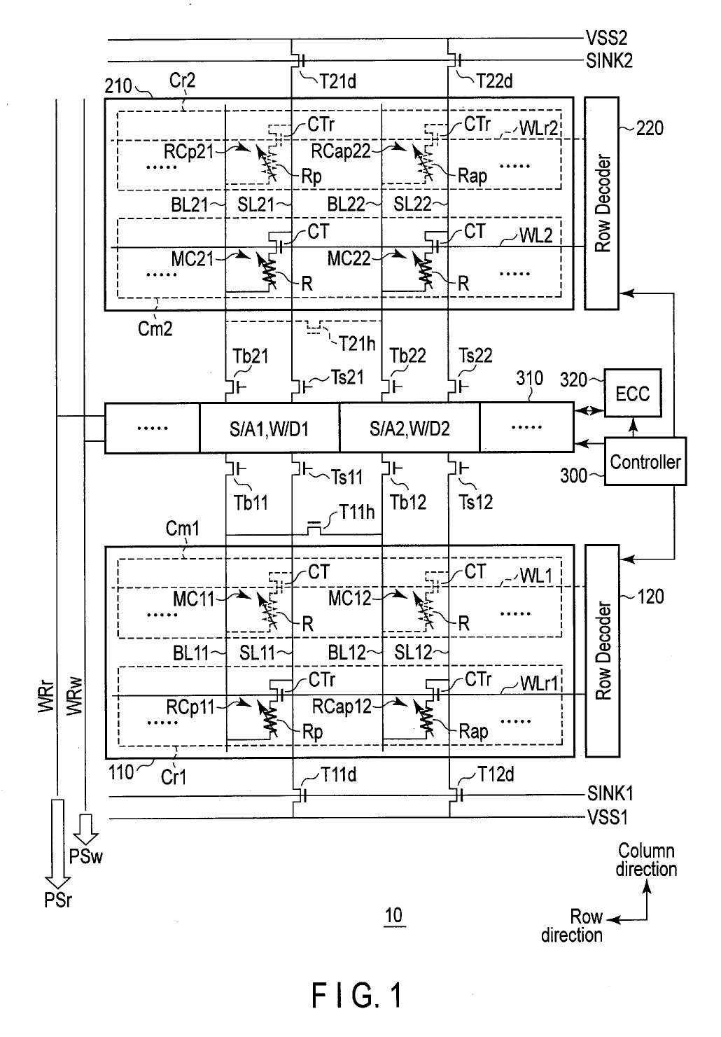

An explanation will be given of a configuration example of an MRAM 10 of the STT type, which is a resistance change memory device according to this embodiment, with reference to FIG. 1. FIG. 1 shows an example of a circuit configuration of a resistance change memory device according to this embodiment.

As shown in FIG. 1, the MRAM 10 includes a first memory cell array 110, a first row decoder 120, a second memory cell array 210, a second row decoder 220, a Read and Write (RW) circuit 310, an Error Correction Code (ECC) circuit 320, and a control circuit 300.

[First Memory Cell Array]

The first memory cell array 110 and the first row decoder 120 are adjacent to the RW circuit 310 on its one side in a column direction (Y-direction). Further, on the one side of the RW circuit 310 in the column direction, control lines SINK1 and VSS1 are provided such that the first memory cell array 110 and the first row decoder 120 are sandwiched between the RW circuit 310 and these lines. The control lines SINK1 and VSS1 extend in a row direction (X-direction) orthogonal to the column direction.

The first memory cell array 110 includes a word line WL1, a reference word line WLr1, a plurality of bit lines BL (BL11, BL12 . . . ), a plurality of source lines SL (SL11, SL12 . . . ), a plurality of memory cells MC (MC11, MC12 . . . ), and a plurality of reference cells RC (RCp11, RCap12 . . . ).

The word line WL1 and the reference word line WLr1 are adjacent to each other in the column direction, and extend in the row direction. The word line WL1 and the reference word line WLr1 are connected to the first row decoder 120 respectively at their one ends.

The bit line BL11 extends in the column direction.

The bit line BL11 is connected at its one end to the RW circuit 310 through the current path of a transistor Tb11. The source line SL11 is adjacent to the bit line BL11 in the row direction, and extends in the column direction. The source line SL11 is connected at its one end to the RW circuit 310 through the current path of a transistor Ts11. The source line SL11 is connected at its other end to the control line VSS1 through the current path of a transistor T11d. The control line VSS1 has the ground potential, and serves as an electric current termination part in a read operation for the first memory cell array 110. The gate of the transistor T11d is connected to the control line SINK1. The electric potential of the control line SINK1 is controlled by the control circuit 300.

The memory cell MC11 is arranged between the bit line BL11 and the source line SL11. The memory cell MC11 includes an MTJ (Magnetic Tunnel Junction) element R as a resistance change element, and a cell transistor CT. The MTJ element R is configured to take a low resistance state and a high resistance state, and is used as a memory element in the MRAM 10. As described later, the MTJ element R is one type of magnetoresistive element. The MTJ element R is connected at its one end to the bit line BL11, and is connected at its other end to one end of the current path of the cell transistor CT. The current path of the cell transistor CT is connected at its other end to the source line SL11. The gate of the cell transistor CT is connected to the word line WL1.

The reference cell RCp11 is arranged between the bit line BL11 and the source line SL11. The reference cell RCp11 includes an MTJ element Rp as a resistance change element, and a cell transistor CTr. The MTJ element Rp takes the low resistance state, and is used as an element for generating a reference current in the MRAM 10. The MTJ element Rp is connected at its one end to the bit line BL11, and is connected at its other end to one end of the current path of the cell transistor CTr. The current path of the cell transistor CTr is connected at its other end to the source line SL11. The gate of the cell transistor CTr is connected to the reference word line WLr1.

A configuration including the bit line BL12, the source line SL12, the memory cell MC12, and the reference cell RCap12 is adjacent in the row direction to the above-described configuration including the bit line BL11, the source line SL11, the memory cell MC11, and the reference cell RCp11 and has arrangements and connection forms similar to those of this configuration.

The bit line BL12 is adjacent to the source line SL11 in the row direction. The source line SL12 is adjacent to the bit line BL12 in the row direction. The bit line BL12 and the source line SL12 extend in the column direction. The bit line BL12 and the source line SL12 are connected at their one ends to the RW circuit 310 respectively through the current paths of transistors Tb12 and Ts12. The source line SL12 is connected at its other end to the control line VSS1 through the current path of a transistor T12d. The gate of the transistor T12d is connected to the control line SINK1. The bit line BL12 is connected to the bit line BL11 through the current path of a transistor T11h.

The memory cell MC12 and the reference cell RCap12 are arranged between the bit line BL12 and the source line SL12. The memory cell MC12 is adjacent to the memory cell MC11 in the row direction. The reference cell RCap12 is adjacent to the reference cell RCp11 in the row direction.

The memory cell MC12 includes an MTJ element R and a cell transistor CT, which have arrangements and connection forms similar to those of the MTJ element R and the cell transistor CT of the memory cell MC11. Specifically, the MTJ element R is connected at its one end to the bit line BL12, and is connected at its other end to one end of the current path of the cell transistor CT. The current path of the cell transistor CT is connected at its other end to the source line SL12. The gate of the cell transistor CT is connected to the word line WL1.

The reference cell RCp12 includes an MTJ element Rap and a cell transistor CTr. The MTJ element Rap takes the high resistance state, and is used as an element for generating a reference current in the MRAM 10. The MTJ element Rap and the cell transistor CTr have arrangements and connection forms similar to those of the MTJ element Rp and the cell transistor CTr of the reference cell RCp11. Specifically, the MTJ element Rap is connected at its one end to the bit line BL12, and is connected at its other end to one end of the current path of the cell transistor CTr. The current path of the cell transistor CTr is connected at its other end to the source line SL12. The gate of the cell transistor CTr is connected to the reference word line WLr1.

In a write operation, the first row decoder 120 supplies a voltage to the word line WL1 in accordance with control of the control circuit 300. In a read operation, the first row decoder 120 supplies voltages to the word line WL1 and the reference word line WLr1 in accordance with control of the control circuit 300.

In the first memory cell array 110, the configuration including the word line WL1, the plurality of bit lines BL (BL11, BL12 . . . ), the plurality of source lines SL (SL11, SL12 . . . ), and the plurality of memory cells MC (MC11, MC12 . . . ) can be considered as a memory circuit Cm1. The memory circuit Cm1 may include the control lines SINK1 and VSS1, and may further include the first row decoder 120 and the control circuit 300. In the first memory cell array 110, the configuration including the reference word line WLr1, the plurality of bit lines BL (BL11, BL12 . . . ), the plurality of source lines SL (SL11, SL12 . . . ), and the plurality of reference cells RC (RCp11, RCap12 . . . ) can be considered as a reference circuit Cr1. The reference circuit Cr1 may include the control lines SINK1 and VSS1, and may further include the first row decoder 120 and the control circuit 300.

[Second Memory Cell Array]

The second memory cell array 210 and the second row decoder 220 are adjacent to the RW circuit 310 on its other side in the column direction (Y-direction). Further, on the other side of the RW circuit 310 in the column direction, control lines SINK2 and VSS2 are provided such that the second memory cell array 210 and the second row decoder 220 are sandwiched between the RW circuit 310 and these lines. The control lines SINK2 and VSS2 extend in the row direction.

The second memory cell array 210 includes a word line WL2, a reference word line WLr2, a plurality of bit lines BL (BL21, BL22 . . . ), a plurality of source lines SL (SL21, SL22 . . . ), a plurality of memory cells MC (MC21, MC22 . . . ), and a plurality of reference cells RC (RCp21, RCap22 . . . ).

The word line WL2 and the reference word line WLr2 are adjacent to each other in the column direction, and extend in the row direction. The word line WL2 and the reference word line WLr2 are connected to the second row decoder 220 respectively at their one ends.

The bit line BL21 and the source line SL21 are adjacent to each other in the row direction, and extend in the column direction. The bit line BL21 and the source line SL21 are connected at their one ends to the RW circuit 310 respectively through transistors Tb21 and Ts21. The source line SL21 is connected at its other end to the control line VSS2 through the current path of a transistor T21d. The control line VSS2 has the ground potential, and serves as an electric current termination part in a read operation for the second memory cell array 210. The gate of the transistor T21d is connected to the control line SINK2. The electric potential of the control line SINK2 is controlled by the control circuit 300.

The memory cell MC21 and the reference cell RCp21 are arranged between the bit line BL21 and the source line SL21.

The memory cell MC21 includes an MTJ element R and a cell transistor CT. The MTJ element R is connected at its one end to the bit line BL21, and is connected at its other end to one end of the current path of the cell transistor CT. The current path of the cell transistor CT is connected at its other end to the source line SL21. The gate of the cell transistor CT is connected to the word line WL2.

The reference cell RCp21 includes an MTJ element Rp and a cell transistor CTr. The MTJ element Rp is connected at its one end to the bit line BL21, and is connected at its other end to one end of the current path of the cell transistor CTr. The current path of the cell transistor CTr is connected at its other end to the source line SL21. The gate of the cell transistor CTr is connected to the reference word line WLr2.

A configuration including the bit line BL22, the source line SL22, the memory cell MC22, and the reference cell RCap22 is adjacent in the row direction to the above-described configuration including the bit line BL21, the source line SL21, the memory cell MC21, and the reference cell RCp21 and has arrangements and connection forms similar to those of this configuration.

The bit line BL22 is adjacent to the source line SL21 in the row direction. The source line SL22 is adjacent to the bit line BL22 in the row direction. The bit line BL22 and the source line SL22 extend in the column direction. The bit line BL22 and the source line SL22 are connected at their one ends to the RW circuit 310 respectively through the current paths of transistors Tb22 and Ts22. The source line SL22 is connected at its other end to the control line VSS2 through the current path of a transistor T22d. The gate of the transistor T22d is connected to the control line SINK2. The bit line BL22 is connected to the bit line BL21 through the current path of a transistor T21h.

The memory cell MC22 and the reference cell RCap22 are arranged between the bit line BL22 and the source line SL22. The memory cell MC22 is adjacent to the memory cell MC21 in the row direction. The reference cell RCap22 is adjacent to the reference cell RCp21 in the row direction.

The memory cell MC22 includes an MTJ element R and a cell transistor CT, which have arrangements and connection forms similar to those of the MTJ element R and the cell transistor CT of the memory cell MC21. The reference cell RCap22 includes an MTJ element Rap and a cell transistor CTr, which have arrangements and connection forms similar to those of the MTJ element Rp and the cell transistor CTr of the reference cell RCp21.

In a write operation, the second row decoder 220 supplies a voltage to the word line WL2 in accordance with control of the control circuit 300. In a read operation, the second row decoder 220 supplies voltages to the word line WL2 and the reference word line WLr2 in accordance with control of the control circuit 300.

In the second memory cell array 210, the configuration including the word line WL2, the plurality of bit lines BL (BL21, BL22 . . . ), the plurality of source lines SL (SL21, SL22 . . . ), and the plurality of memory cells MC (MC21, MC22 can be considered as a memory circuit Cm2. The memory circuit Cm2 may include the control lines VSS2 and SINK2, and may further include the second row decoder 220 and the control circuit 300. In the second memory cell array 210, the configuration including the reference word line WLr2, the plurality of bit lines BL (BL21, BL22 . . . ), the plurality of source lines SL (SL21, SL22 . . . ), and the plurality of reference cells RC (RCp21, RCap22 . . . ) can be considered as a reference circuit Cr2. The reference circuit Cr2 may include the control lines VSS2 and SINK2, and may further include the second row decoder 220 and the control circuit 300.

[RW Circuit]

The RW circuit 310 includes a plurality of sense amplifiers SA (SA1, SA2 . . . ) and a plurality of write drivers WD (WD1, WD2 . . . ). The RW circuit 310 performs read operations and write operations in accordance with control of the control circuit 300.

More specifically, in a write operation, the write driver WD1 suitably supplies voltages to the bit line BL11 and the source line SL11, or to the bit line BL21 and the source line SL21. In a write operation, the write driver WD2 suitably supplies voltages to the bit line BL12 and the source line SL12, or to the bit line BL22 and the source line SL22. In other words, the write driver WD1 controls the write operations of the memory cells MC11 and MC21. The write driver WD2 controls the write operations of the memory cells MC12 and MC22.

In a read operation, the sense amplifier SA1 is suitably and electrically connected to the bit line BL11 and the bit line BL21. In a read operation, the sense amplifier SA2 is suitably and electrically connected to the bit line BL12 and the bit line BL22. In other words, the sense amplifier SA1 controls the read operations of the memory cells MC11 and MC21. The sense amplifier SA2 controls the read operations of the memory cells MC12 and MC22.

Further, in a read operation, the sense amplifiers SA1 and SA2 are electrically connected to the reference cells RCp11 and RCap12, or to the reference cells RCp21 and RCap22. Specifically, the sense amplifier SA1 makes reference to a reference current flowing through the reference cells RCp21 and RCap22 when the data of the memory cell MC11 is read, and makes reference to a reference current flowing through the reference cells RCp11 and RCap12 when the data of the memory cell MC21 is read. The sense amplifier SA2 makes reference to a reference current flowing through the reference cells RCp21 and RCap22 when the data of the memory cell MC12 is read, and makes reference to a reference current flowing through the reference cells RCp11 and RCap12 when the data of the memory cell MC22 is read.

The RW circuit 310 is connected to a write power supply PSw through a wiring line WRw. The RW circuit 310 is supplied with a power supply voltage from the write power supply PSw, and performs write operations to the respective portions. The RW circuit 310 is connected to a read power supply PSr through a wiring line WRr. The RW circuit 310 is supplied with a power supply voltage from the read power supply PSr, and performs read operations to the respective portions.

[ECC Circuit]

The ECC circuit 320 and the RW circuit 310 are mutually connected to each other. The ECC circuit 320 outputs write data, which has been sent from the control circuit 300, to the RW circuit 310. The ECC circuit 320 outputs read data, which has been sent from the RW circuit 310, to the control circuit 300.

When the ECC circuit 320 outputs write data to the RW circuit 310, it performs a predetermined arithmetic operation to generate an error correction code. The ECC circuit 320 couples this error correction code with the write data and outputs this couple to the RW circuit 310. When the ECC circuit 320 outputs read data to the control circuit 300, it detects fault (error) of the read data, based on the error correction code. If an error is detected, the ECC circuit 320 outputs information, such as detection of the error, a memory cell MC associated with the error thus detected, and correct data, to the control circuit 300. The control circuit 300 causes the RW circuit 310 to write the correct data into the memory cell MC associated with the detected error and thereby write back the data of the memory cell MC. The ECC circuit 320 outputs the data thus corrected along with other read data to the control circuit 300.

[Control Circuit]

The control circuit 300 is connected to the ECC circuit 320, the RW circuit 310, the first row decoder 120, and the second row decoder 220. The control circuit 300 receives instructions from outside, and controls the operations of the ECC circuit 320, the RW circuit 310, the first row decoder 120, and the second row decoder 220.

(2) Configuration Example of Resistance Change Element:

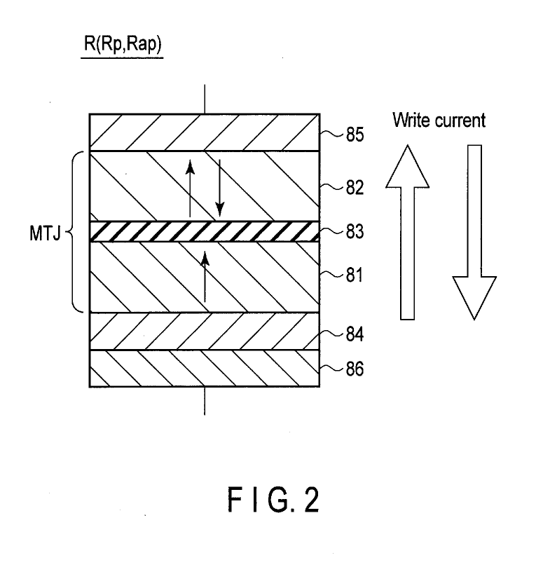

An explanation will be given of a configuration example of an MTJ element R, which is a resistance change element according to this embodiment, with reference to FIG. 2. FIG. 2 schematically shows an example of a memory element included in the resistance change memory device according to this embodiment.

The MTJ element R is configured to take different resistance states in accordance with the direction of a current flowing through the MTJ element R. The phenomenon of showing different resistances depending on the state is called the magnetoresistive effect. The MTJ element R holds data by use of this magnetoresistive effect.

As shown in FIG. 2, the MTJ (Magnetic Tunnel Junction) of the MTJ element R includes at least a fixed layer 81, a recording layer 82, and an insulating layer 83 interposed between these layers. The magnetization of the fixed layer 81 is fixed by a ferromagnetic layer 84. The magnetization of the recording layer 82 is varied depending on the direction of a write current flowing through the layer. Electrode layers 85 and 86 are provided to sandwich the ferromagnetic layer 84, the fixed layer 81, the recording layer 82, and the insulating layer 83.

The MTJ element R shows different resistance states depending on the relative relationship between the magnetization direction of the fixed layer 81 and the magnetization direction of the recording layer 82. Specifically, the MTJ element R is configured to hold data of “1” or “0” depending on whether the magnetization directions of the fixed layer 81 and the recording layer 82 are in a parallel state (low resistance state) or in an anti-parallel state (high resistance state). It is arbitrarily set as to which one of the parallel state (low resistance state) and the anti-parallel state (high resistance state) corresponds to data of “1” or “0”.

As described above, each of the MTJ elements Rp and Rap used for the reference cells RCp and RCap is also configured as a resistance change element. Specifically, for example, each of the MTJ elements Rp and Rap has a structure substantially the same as that of the MTJ element R and is produced by steps substantially the same as those for the MTJ element R. In other words, for example, each of the MTJ elements Rp and Rap includes one of a plurality of structures formed as the MTJ element R.

However, the MTJ element R used for the memory cell MC is configured to take the low resistance state and the high resistance state. On the other hand, each of the MTJ elements Rp and Rap use for the reference cells RCp and RCap is configured to take either one of the low resistance state and the high resistance state. Specifically, the MTJ element Rp is fixed in the low resistance state, and the MTJ element Rap is fixed in the high resistance state.

(3) Operation of Resistance Change Memory Device:

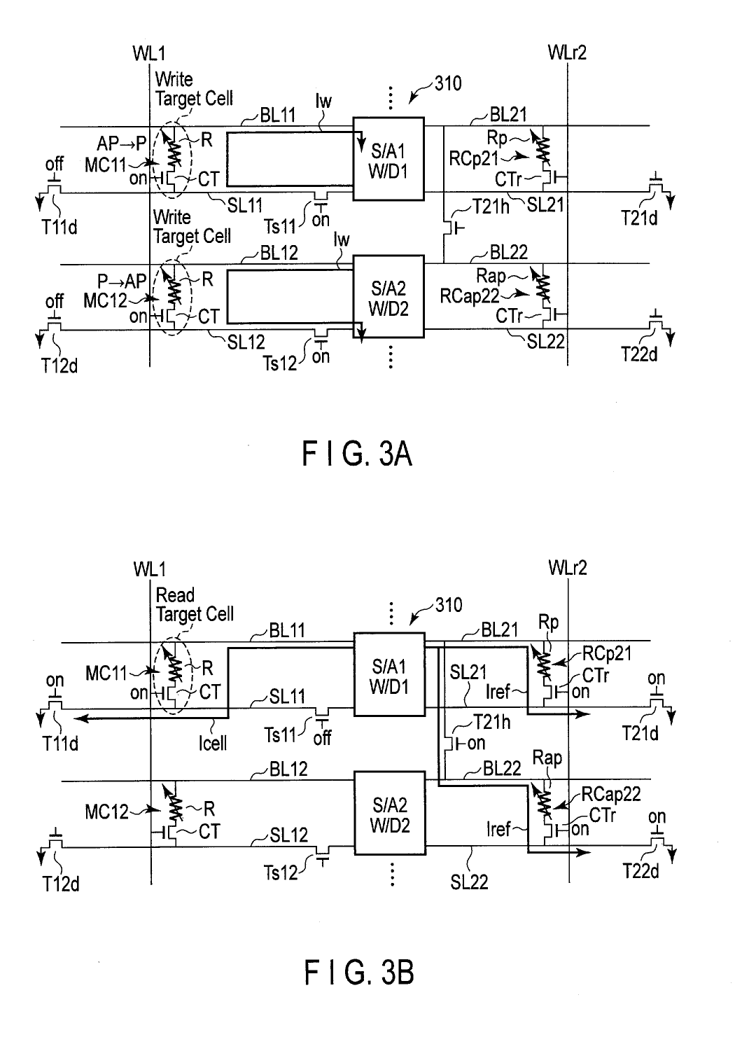

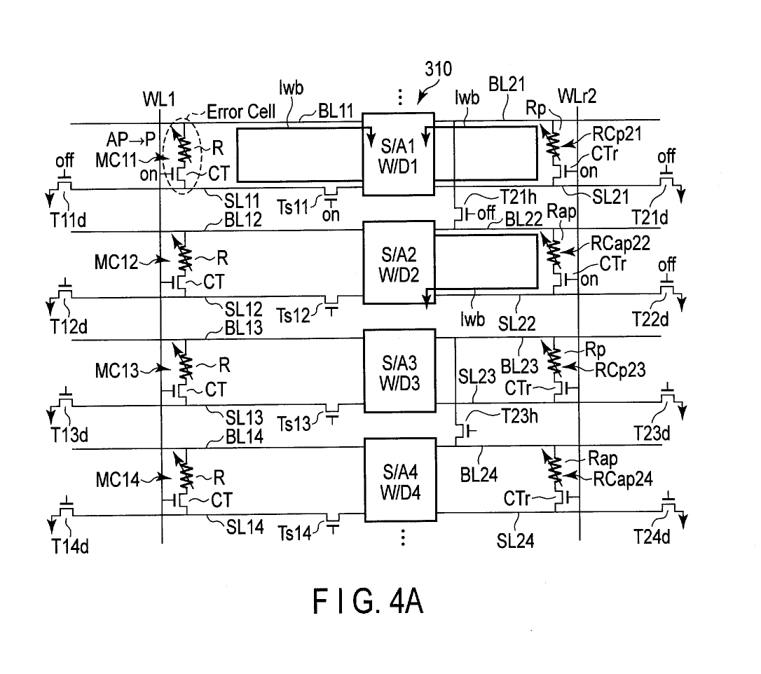

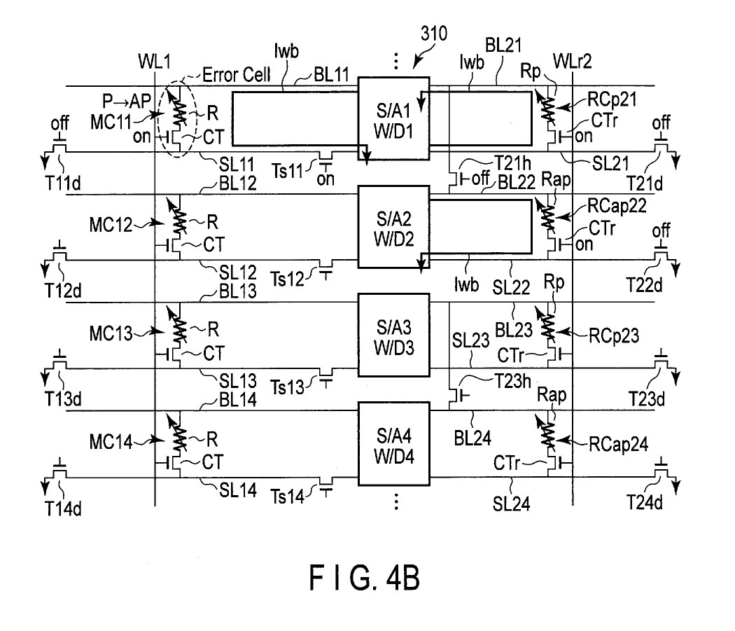

An explanation will be given of a write operation, a read operation, and a write back operation in the MRAM 10, with reference to FIGS. 3A, 3B, 4A, and 4B. These drawings show only configurations necessary for explanation. For example, of the transistors Tb and Ts connected to the RW circuit 310, only the transistor Ts on the source line SL side is shown, in order to clearly indicate the direction of a current flowing between the bit line BL and the source line SL. Further, the reference cells RCp11 and RCap12 and the memory cells MC21 and MC22 are not shown.

Hereinafter, for example, it is assumed that the data held in the MTJ element R in the parallel state (low resistance state) is data “0”, and the data held in the MTJ element R in the anti-parallel state (high resistance state) is data “1”. Further, according to this assumption, it can be said that the reference cell RCp is fixed with data “0” held therein, and the reference cell RCap is fixed with data “1” held therein.

[Write Operation]

FIG. 3A shows a write operation of the resistance change memory device according to this embodiment. More specifically, FIG. 3A shows an example of a write operation performed to the memory cells MC11 and MC12 as write target cells. The operation described below is mainly performed by the RW circuit 310 in accordance with control of the control circuit 300 shown in FIG. 1, which has received an instruction from outside.

As shown in FIG. 3A, in the memory cell MC11, the MTJ element R comes into the low resistance state, i.e., the parallel state (“P”), and so data “0” is written into the memory cell MC11.

When write is performed to the memory cell MC11, the write driver WD1 supplies voltages to the bit line BL11 and the source line SL11. Specifically, the write driver WD1 sets the bit line BL11 to the ground potential and sets the source line SL11 to the power supply potential. Further, the word line WL1 is set at an “H” level, and the cell transistor CT of the memory cell MC11 is turned on. Although not shown in FIG. 3A, the reference word line WLr1 is set at an “L” level, and the cell transistor CTr of the reference cell RCp11 is set in an off-state, and so there is no current flowing through the reference cell RCp11.

Under the conditions described above, a write current path is formed such that a write current Iw flows from the power supply potential through the source line SL11 and the bit line BL11 in this order to the ground potential. Specifically, the write current Iw flows from the power supply potential through the source line SL11, the memory cell MC11, and the bit line BL11 in this order into the ground potential. Consequently, the MTJ element R comes into the parallel state (“P”), and data “0” is written into the memory cell MC11. In other words, data “0” is written into a data bit.

As shown in FIG. 3A, in the memory cell MC12, the MTJ element R comes into the high resistance state, i.e., the anti-parallel state (“AP”), and so data “1” is written into the memory cell MC12.

When write is performed to the memory cell MC12, the write driver WD1 supplies voltages to the bit line BL12 and the source line SL12. Specifically, the write driver WD1 sets the bit line BL12 to the power supply potential and sets the source line SL12 to the ground potential. Further, the word line WL1 is set at an “H” level, and the cell transistor CT of the memory cell MC12 is turned on. Although not shown in FIG. 3A, the reference word line WLr1 is set at an “L” level, and the cell transistor CTr of the reference cell RCap12 is set in an off-state, and so there is no current flowing through the reference cell RCap12.

Under the conditions described above, a write current path is formed such that a write current Iw flows from the power supply potential through the bit line BL12 and the source line SL12 in this order to the ground potential. Specifically, the write current Iw flows from the power supply potential through the bit line BL12, the memory cell MC12, and the source line SL12 in this order into the ground potential. Consequently, the MTJ element R comes into the anti-parallel state (“AP”), and data “1” is written into the memory cell MC12. In other words, data “1” is written into a data bit.

As described above, when a current flows through a memory cell MC from the source line SL side to the bit line BL side, data “0” is written into this memory cell MC. Further, when a current flows through a memory cell MC in the opposite direction from the bit line BL side to the source line SL side, data “1” is written into this memory cell MC.

However, the MTJ element R can be arbitrarily set as to which current flowing direction brings it into the parallel state or anti-parallel state. Specifically, the MTJ element R may be configured such that the MTJ element R comes into the parallel state when a current flows through the memory cell MC from the bit line BL side to the source line SL side. The MTJ element R may be configured such that the MTJ element R comes into the anti-parallel state when a current flows through the memory cell MC from the source line SL side to the bit line BL side.

[Read Operation]

FIG. 3B shows a read operation of the resistance change memory device according to this embodiment. More specifically, FIG. 3B shows an example of a read operation performed to the memory cell MC11 as a read target cell. At this time, it makes reference to a reference current generated by the reference cells RCp21 and RCap22. The operation described below is also mainly performed by the RW circuit 310 in accordance with control of the control circuit 300 shown in FIG. 1, which has received an instruction from outside.

As shown in FIG. 3B, when read is performed to the memory cell MC11, the bit line BL11 is electrically connected to the sense amplifier SA1. Further, the control line SINK1 is set at an “H” level, and the transistor T11d is turned on. Consequently, the source line SL11 is electrically connected to the control line VSS1 and is set to the ground potential. Further, the word line WL1 is set at an “H” level, and the cell transistor CT of the memory cell MC11 is turned on. Although not shown in FIG. 3B, the reference word line WLr1 is set at an “L” level, and the cell transistor CTr of the reference cell RCp11 is set in an off-state, and so there is no current flowing through the reference cell RCp11.

Under the conditions described above, a read current path is formed such that a read current Icell flows from the sense amplifier SA1 through the bit line BL11 and the source line SL11 in this order to the control line VSS1. Specifically, the read current Icell flows from the sense amplifier SA1 through the bit line BL11, the memory cell MC11, and the source line SL11 in this order into the ground potential.

On the other hand, a reference current Iref is generated in each of the reference cells RCp21 and RCap22.

Specifically, the bit line BL21 is electrically connected to the sense amplifier SA1. Further, the transistor T21h is turned on, and the bit line BL22 is electrically connected to the sense amplifier SA1 through the bit line BL21. Further, the control line SINK2 is set at an “H” level, and the transistors T21d and T22d are turned on. Consequently, each of the source lines SL21 and SL22 is electrically connected to the control line VSS1 and is set to the ground potential. Further, the reference word line WLr2 is set at an “H” level, and the cell transistors CTr of the reference cells RCp21 and RCap22 are turned on. Although not shown in FIG. 3B, the word line WL2 is set at an “L” level, and the respective cell transistors CT of the memory cells MC21 and MC22 are set in an off-state, and so there is no current flowing through the memory cells MC21 and MC22.

Under the conditions described above, a current path is formed such that a current flows from the sense amplifier SA1 through the bit line BL21 and the source line SL21 in this order to the control line VSS2. Specifically, this current flows from the sense amplifier SA1 through the bit line BL21, the reference cell RCp21, and the source line SL21 in this order into the ground potential.

Further, a current path is formed such that a current flows from the sense amplifier SA1 through the bit line BL22 and the source line SL22 in this order to the control line VSS2. Specifically, this current flows from the sense amplifier SA1 through the bit line BL22, the reference cell RCap22, and the source line SL22 in this order into the ground potential. At this time, since the transistor T21h is set in an on-state, the two current paths are equipotential. Accordingly, these two current paths serve as a reference current path for the reference current Iref to flow therethrough, wherein the reference current Iref is a current having an intermediate value between the value of a current flowing through the reference cell RCp21 in the low resistance state and the value of a current flowing through the reference cell RCap22 in the high resistance state.

The sense amplifier SA1 compares the read current Icell flowing through the read current path including the memory cell MC11 with the reference current Iref flowing through the reference current path including the reference cells RCp21 and RCap22. The sense amplifier SA1 outputs a read signal in accordance with this comparison result. Based on this read signal, data (“0” or “1”) held in the memory cell MC11 is discriminated. Specifically, when the MTJ element R of the memory cell MC11 is in the low resistance state, the read current Icell is detected as being higher than the reference current Iref. In this case, it is determined that the memory cell MC11 holds data “0”. When the MTJ element R of the memory cell MC11 is in the high resistance state, the read current Icell is detected as being lower than the reference current Iref. In this case, it is determined that the memory cell MC11 holds data “1”. In other words for the read operation described above, it compares the data of a data bit with the data of a reference bit and thereby discriminates the data of the data bit.

[Write Back Operation]

FIGS. 4A and 4B show a write back operation of the resistance change memory device according to this embodiment. The operation described below is mainly performed by the RW circuit 310 and the ECC circuit 320 in accordance with control of the control circuit 300, which has received an instruction from outside.

When the write described above is performed to the memory cell MC, the ECC circuit 320 receives write data, which has been received by the control circuit 300 from outside. The ECC circuit 320 performs a predetermined arithmetic operation based on this write data to generate an error correction code, and couples it with the write data. The ECC circuit 320 transfers the write data coupled with the error correction code to the RW circuit 310. The RW circuit 310 writes this write data coupled with the error correction code into the memory cell MC, as described above.

When the read described above is performed to the memory cell MC, the ECC circuit 320 receives, from the RW circuit 310, data read from the memory cell MC along with the error correction code coupled with the write data. The ECC circuit 320 compares the read data with the error correction code and thereby determines whether there is an error in the read data. If it determines that there is an error in the read data, the ECC circuit 320 outputs information about the error to the control circuit 300.

When write back is performed to the memory cell MC, the control circuit 300 causes the RW circuit 310 to write the correct data into the memory cell MC associated with the detected error and thereby write back the data of the memory cell MC.

(Write Back with Data “0” to Memory Cell)

As described above, data read from the memory cell MC may include an error. For example, such an error is caused by writing erroneous data into the memory cell MC during its write period. Further, for example, such an error is also caused if data is accidentally rewritten and altered while the data is held in the memory cell MC.

FIG. 4A shows an example of a write back operation to reset error data (“1”) held in the memory cell MC11 to correct data (“0”) when the memory cell MC11 is considered as an error cell associated with a detected error, i.e., as a write back target cell. In other words, the MTJ element R in the anti-parallel state (“AP”) is changed into the parallel state (“P”) by this write back. As shown in FIG. 4A, this write back operation is performed in the same way as the write operation performed to the memory cell MC11 shown in FIG. 3A.

Incidentally, as regards errors to be detected in a read period, an error may be caused by the reference cells RCp and RCap. For example, there is a case where the data held in either of the reference cells RCp and RCap is accidentally rewritten and altered, and so the reference current generated by the reference cells RCp and RCap is shifted. If the reference current serving as a data discrimination reference is shifted, there may be a case where data held in a memory cell MC is determined as an error even though the data is correct.

In light of this, according to this embodiment, for example, the control circuit 300 causes the RW circuit 310 to write back the data of the reference cells RCp and RCap in parallel with the write back of the memory cell MC.

More specifically, write back is performed also to the reference cells RCp21 and RCap22 configured to be electrically connected to the sense amplifier SA1 as well as the memory cell MC11 being connected to, in the data read period. In other words, write back is performed to the reference cells RCp21 and RCap22 configured to be referred to when the data of the memory cell MC11 is read.

As shown in FIG. 4A, when write back is performed to the reference cell RCp21, data (“0”), which is originally held in the reference cell RCp21, is written again into the reference cell RCp21.

When write back is performed to the reference cell RCp21, the write driver WD1 supplies voltages to the bit line BL21 and the source line SL21. Specifically, the write driver WD1 sets the bit line BL21 to the ground potential, and sets the source line SL21 to the power supply potential. Further, the reference word line WLr2 is set at an “H” level, and the cell transistor CTr of the reference cell RCp21 is turned on. Although not shown in FIG. 4A, the word line WL2 is set at an “L” level, and the cell transistor CT of the memory cell MC21 is set in an off-state, and so there is no current flowing through the memory cell MC21.

Under the conditions described above, a write back current path is formed such that a write back current Iwb flows from the power supply potential through the source line SL21 and the bit line BL21 in this order to the ground potential. Specifically, the write back current Iwb flows from the power supply potential through the source line SL21, the reference cell RCp21, and the bit line BL21 in this order into the ground potential. Consequently, the MTJ element Rp included in the reference cell RCp21 comes into the parallel state (“P”), and data “0” is written back into the reference cell RCp21, regardless of the state of this MTJ element Rp before write back.

As shown in FIG. 4A, when write back is performed to the reference cell RCap22, data (“1”), which is originally held in the reference cell RCap22, is written again into the reference cell RCap22.

When write back is performed to the reference cell RCap22, the write driver WD2 supplies voltages to the bit line BL22 and the source line SL22. Specifically, the write driver WD2 sets the bit line BL22 to the power supply potential, and sets the source line SL22 to the ground potential. Further, the reference word line WLr2 is set at an “H” level, and the cell transistor CTr of the reference cell RCap22 is turned on. Although not shown in FIG. 4A, the word line WL2 is set at an “L” level, and the cell transistor CT of the memory cell MC22 is set in an off-state, and so there is no current flowing through the memory cell MC22.

Under the conditions described above, a write back current path is formed such that a write back current Iwb flows from the power supply potential through the bit line BL22 and the source line SL22 in this order to the ground potential. Specifically, the write back current Iwb flows from the power supply potential through the bit line BL22, the reference cell RCap22, and the source line SL22 in this order into the ground potential. Consequently, the MTJ element Rap included in the reference cell RCap22 comes into the anti-parallel state (“AP”), and data “1” is written back into the reference cell RCap22, regardless of the state of this MTJ element Rap before write back.

(Write Back with Data “1” to Memory Cell)

FIG. 4B shows an example of a write back operation to reset error data (“0”) held in the memory cell MC11 to correct data (“1”) when the memory cell MC11 is considered as an error cell associated with a detected error, i.e., as a write back target cell. In other words, the MTJ element R in the parallel state (“P”) is changed into the anti-parallel state (“AP”) by this write back. As shown in FIG. 4B, this write back operation is performed in the same way as the write operation performed to the memory cell MC12 shown in FIG. 3A.

Further, at this time, the control circuit 300 causes the RW circuit 310 to perform write back also to the reference cells RCp21 and RCap22 electrically connected to the sense amplifier SA1 as well as the memory cell MC11 being connected to. This write back operation is performed in the same way as the write back operation performed to the reference cells RCp21 and RCap22 shown in FIG. 4A.

As described above, when data write back is performed to the reference cell RCp, a current flows through the reference cell RCp from the source line SL side to the bit line BL side. When data write back is performed to the reference cell RCap, a current flows through the reference cell RCap from the bit line BL side to the source line SL side. However, the MTJ element Rp can be arbitrarily set in terms of which current flowing direction brings it into the parallel state, and the MTJ element Rap can be arbitrarily set in terms of which current flowing direction brings it into the anti-parallel state.

Further, as described above, the write back operation according to this embodiment includes an operation to write correct data into a memory cell MC associated with a detected error and thereby correct the data of the memory cell MC. Further, the write back operation according to this embodiment includes an operation to overwrite correct data into a memory cell MC associated with a detected error even though it holds the same correct data therein. Further, the write back operation according to this embodiment includes an operation to write the same data as the original data into reference cells RCp and RCap configured to be referred to by a memory cell MC associated with a detected error, and thereby correct or overwrite the data of the reference cells RCp and RCap.

In other words for the write back operation described above, if an error is detected about the data of a data bit, write back is performed to the data of the data bit associated with the detected error and the data of the reference bits. For example, the write back of the data of the data bit and the write back of the data of the reference bit are performed in parallel with one another.

In the description described above, an example is given of a case where one reference cell RCp and one reference cell RCap are used to generate a reference current when the data of one memory cell MC is read, but this is not limiting. It may be designed such that a plurality of sets of reference cells RCp and RCap, in which each set is formed of one reference cell RCp and one reference cell RCap, are used to generate reference currents when the data of one memory cell MC is read. In other words, a plurality of sets of reference cells RCp and RCap, in which the numbers of the reference cells RCp and RCap are equal to each other, may be used in accordance with a majority average thereof to generate reference currents. In this case, the read accuracy of the memory cell MC can be improved all the more. If a plurality of sets of reference cells RCp and RCap are set to correspond to one memory cell MC, the plurality of sets of reference cells RCp and RCap may be arranged, for example, at a position opposite to the memory cell MC with the sense amplifier SA interposed therebetween, a position adjacent to this position, and a position around this position.

If a plurality of sets of reference cells RCp and RCap are used for one memory cell MC, write back may be performed to at least one set of reference cells RCp and RCap, selected from the plurality of sets of reference cells RCp and RCap, when write back is performed to the memory cell MC. Alternatively, write back may be performed to several sets of reference cells RCp and RCap or all the sets of reference cells RCp and RCap.

However, when write back is performed to part of the plurality of sets of reference cells RCp and RCap, the reference cells RCp and RCap connected to the write back target memory cell MC through the shortest current path are preferably included in the write back targets. For example, the shortest current path means that the wiring line connected from the memory cell MC through the sense amplifier SA is the shortest. Further, for example, in terms of the physical arrangement, it is preferable that the write back targets include the reference cells RCp and RCap positioned opposite to the memory cell MC with the sense amplifier SA interposed therebetween. Alternatively, it is preferable that the write back targets include the reference cells RCp and RCap positioned closest to the memory cell MC, reference cells RCp and RCap positioned adjacent to them, and reference cells RCp and RCap positioned around them.

(4) Current Value in Resistance Change Memory Device:

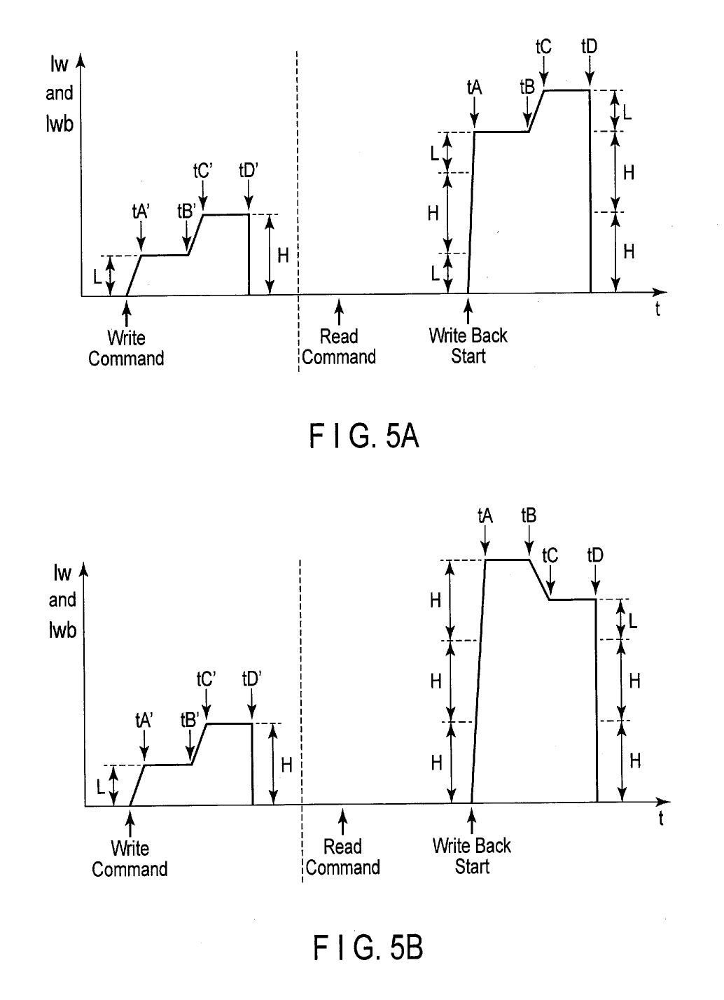

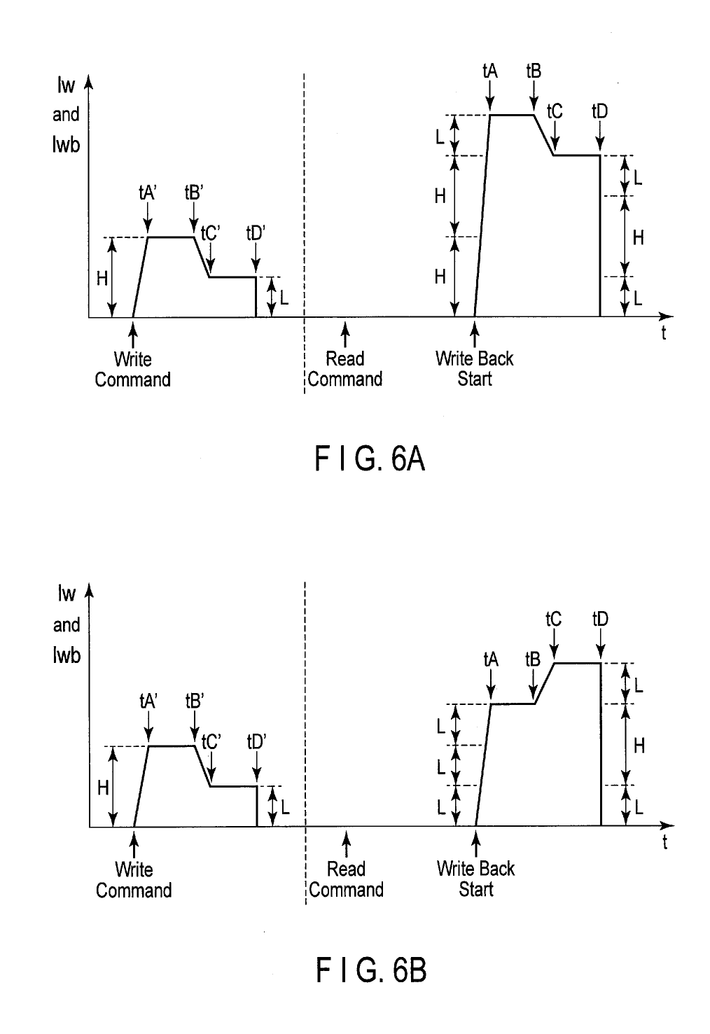

An explanation will be given of the value of a current flowing through the MRAM 10 described above in various operations of the MRAM 10, with reference to FIGS. 5A, 5B, 6A, and 6B. FIGS. 5A to 6B show examples of the value of a current flowing through the resistance change memory device according to this embodiment. In FIGS. 5A to 6B, the horizontal axis denotes time (t), and the vertical axis denotes the values of the write current and the write back current (Iw and Iwb).

Each of the current values shown in FIGS. 5A to 6B is the value of a current supplied from the write power supply PSw shown in FIG. 1. Specifically, the current values shown in FIGS. 5A to 6B are the values of the write current and the write back current supplied from the write power supply PSw shown in FIG. 1 through the wiring line WRw to the write driver WD. The current values mentioned here do not include the value of a current supplied from the read power supply PSr shown in FIG. 1.

More specifically, FIGS. 5A to 6B show examples of a current supplied to the write driver WD in the write operation, the read operation, and the write back operation, in a case where data is written into the memory cell MC. Particularly, as regards the write back operation, FIGS. 5A to 6B respectively show examples of current values obtained in a case where there is one operation target memory cell MC and this memory cell MC is written back with data “0” or “1”, and when an error has been caused in the data of the memory cell MC or an error has been caused in the data of either one of the reference cells RCp and RCap.

[Write Back with Data “0” to Memory Cell]

The current values shown in FIGS. 5A and 5B are examples of the values of a current respectively supplied to the write driver WD in a case where data “0” is written into one memory cell MC, the data of this memory cell MC is read, and an error is detected about the data of this memory cell MC, and this memory cell MC is written back with data “0”.

As shown in FIGS. 5A and 5B, when data “0” is written into one memory cell MC, a write command is supplied to the control circuit 300 from outside. Based on this, the control circuit 300 controls respective relevant portions. Specifically, the write driver WD is supplied with a current from the write power supply PSw, and the write driver WD starts the write operation of the memory cell MC. Upon start of the write operation, the current value varies along with a change in the state of the memory cell MC.

The memory cell MC holds data “1” at first. Accordingly, only a relatively low write current flows through the memory cell MC. Thus, during the first part of the write operation, the current value is relatively low (L). The first part of the write operation mentioned here designates a period from the time when the current supplied to the write driver WD becomes stable to take a constant value (tA′ in the drawings) to the time when the current starts an increase or decrease (tB′ in the drawings). Thereafter, when the data of the memory cell MC is rewritten into data “0” by the write current, a relatively high write current starts flowing through the memory cell MC. Thus, during the second part of the write operation, the current value is relatively high (H). The second part of the write operation mentioned here designates a period from the time when the current value becomes stable to take a constant value (tC′ in the drawings), after the current value starts an increase or decrease at tB′ in the drawings, to the time when the current supply to the write driver WD is stopped (tD′ in the drawings). Further, the value of a current that flows during the second part of the write operation is also referred to as the value of a current that flows when data has been written into the memory cell MC or MTJ element R.

As described above, when data “0” is written into one memory cell MC, the value of a current that flows during the second part of the write operation is also referred to as Ip. In other words, the current value Ip is the value of a current that flows when data of one bit in the low resistance state has been written into the MTJ element R. The current value Ip is also equal to the value of a current that flows when data of one bit in the low resistance state has been written (written back) into the MTJ element Rp of the reference cell RCp.

When data is read from the one memory cell MC described above, a read command is supplied to the control circuit 300 from outside. Based on this, the control circuit 300 controls respective relevant portions. Specifically, the write driver WD is supplied with a current from the read power supply PSr, but is not supplied with any current from the write power supply PSw. Consequently, the current value in FIGS. 5A and 5B is kept at zero.

If an error is detected about the data read from the one memory cell MC described above, the control circuit 300 starts the write back operation by use of the write driver WD. The write driver WD is supplied with a current from the write power supply PSw. The write back operation is performed to the one memory cell MC associated with the detected error and to one set of reference cells RCp and RCap for generating a reference current, in parallel with one another.

At this time, as a reason for the memory cell MC being determined as an error, there may be a case where incorrect determination is made due to an error caused in the reference cells RCp and RCap, as well as a case where an error has been actually caused in the memory cell MC. Specifically, various states can exist as the states of the respective cells MC, RCp, and RCap before the write back. For example, there is a case where the memory cell MC has an error actually caused therein while the reference cells RCp and RCap hold correct data, a case where not only the memory cell MC but also the reference cells RCp and RCap have an error caused therein, or a case where the memory cell MC holds correct data while either one of the reference cells RCp and RCap has an error caused therein.

FIG. 5A shows an example where the memory cell MC holds error data (“1”) while the reference cells RCp and RCap respectively hold correct data (“0” and “1”).

The memory cell MC holds data “1” at first. Accordingly, during the first part of the write back operation (tA-tB), the current flowing through the memory cell MC is relatively low (L). Thereafter, the data of the memory cell MC is rewritten into data “0”, and so, during the second part of the write back operation (tC−tD), the current flowing through the memory cell MC is relatively high (H).

The reference cell RCp holds data “0” from the beginning, and further keeps data “0” thereafter. Accordingly, during both of the first part and the second part of the write back operation, the current flowing through the reference cell RCp is kept relatively high (H).

The reference cell RCap holds data “1” from the beginning, and further keeps data “1” thereafter. Accordingly, during both of the first part and the second part of the write back operation, the current flowing through the reference cell RCap is kept relatively low (L).

Under the conditions described above, the value of a current that flows during the write back operation is the total value of the currents flowing through the respective cells MC, RCp, and RCap. Specifically, the results of a current value are a value (L+H+L) during the first part of the write back operation (tA-tB) and a value (H+H+L) during the second part of the write back operation (tC-tD).

FIG. 5B shows an example where the memory cell MC and the reference cell RCp hold correct data (both are “0”) while the reference cell RCap holds error data (“0”). Thus, FIG. 5B shows an example where the reference current is shifted due to the error data held in the reference cell RCap, and the memory cell MC is thereby determined as an error.

The memory cell MC and the reference cell RCp hold data “0” from the beginning, and further keep data “0” thereafter. Accordingly, during both of the first part (tA-tB) and the second part (tC-tD) of the write back operation, the current flowing through each of the memory cell MC and the reference cell RCp is kept relatively high (H).

The reference cell RCap holds data “0” at first. Accordingly, during the first part of the write back operation, the current flowing through the reference cell RCap is relatively high (H). Thereafter, the data of the reference cell RCap is rewritten into data “1”, and so, during the second part of the write back operation, the current flowing through the reference cell RCap is relatively low (L).

Under the conditions described above, the results of a current value are a value (H+H+H) during the first part of the write back operation (tA-tB) and a value (H+H+L) during the second part of the write back operation (tC-tD).

As regards the current value obtained when data “0” is written back into the memory cell MC, there are various examples other than the examples shown in FIGS. 5A and 5B. Thus, the value of a current that flows during the first part of the write back operation varies. However, the value of a current that flows during the second part of the write back operation, i.e., when the respective cells MC, RCp, and RCap have been written back with correct data, is a value (H+H+L) in any case.

[Write Back with Data “1” to Memory Cell]

The current values shown in FIGS. 6A and 6B are examples of the values of a current respectively supplied to the write driver WD in a case where data “1” is written into one memory cell MC, the data of this memory cell MC is read, and an error is detected about the data of this memory cell MC, and this memory cell MC is written back with data “1”.

As shown in FIGS. 6A and 6B, before data “1” is written into one memory cell MC, the memory cell MC holds data “0” at first. Thus, during the first part of the write operation (tA′-tB′), the current value is relatively high (H). Thereafter, the data of the memory cell MC is rewritten into data “1”, and so, during the second part of the write operation (tC′-tD′), the current value is relatively low (L).

As described above, when data “1” is written into one memory cell MC, the value of a current that flows during the second part of the write operation is also referred to as Iap. In other words, the current value Iap is the value of a current that flows when data of one bit in the high resistance state has been written into the MTJ element R. The current value Iap is also equal to the value of a current that flows when data of one bit in the high resistance state has been written (written back) into the MTJ element Rap of the reference cell RCap.

When data is read from the one memory cell MC described above, the write power supply PSw does not supply any current, and so the current value in FIGS. 6A and 6B is kept at zero.

If an error is detected about the data read from the one memory cell MC described above, the control circuit 300 starts the write back operation by use of the write driver WD.

FIG. 6A shows an example where the memory cell MC holds error data (“0”) while the reference cells RCp and RCap respectively hold correct data (“0” and “1”).

The memory cell MC holds data “0” at first. Accordingly, during the first part of the write back operation (tA-tB), the current flowing through the memory cell MC is relatively high (H). Thereafter, the data of the memory cell MC is rewritten into data “1”, and so, during the second part of the write back operation (tC-tD), the current flowing through the memory cell MC is relatively low (L).

The reference cell RCp holds data “0” from the beginning, and further keeps data “0” thereafter. Accordingly, during both of the first part and the second part of the write back operation, the current flowing through the reference cell RCp is kept relatively high (H).

The reference cell RCap holds data “1” from the beginning, and further keeps data “1” thereafter. Accordingly, during both of the first part and the second part of the write back operation, the current flowing through the reference cell RCap is kept relatively low (L).

Under the conditions described above, the results of a current value are a value (H+H+L) during the first part of the write back operation (tA-tB) and a value (L+H+L) during the second part of the write back operation (tC-tD).

FIG. 6B shows an example where the memory cell MC and the reference cell RCap hold correct data (both are “1”) while the reference cell RCp holds error data (“1”). Thus, FIG. 6B shows an example where the reference current is shifted due to the error data held in the reference cell RCp, and the memory cell MC is thereby determined as an error.

The memory cell MC and the reference cell RCap hold data “1” from the beginning, and further keep data “1” thereafter. Accordingly, during both of the first part (tA-tB) and the second part (tC-tD) of the write back operation, the current flowing through each of the memory cell MC and the reference cell RCap is kept relatively low (L).

The reference cell RCp holds data “1” at first. Accordingly, during the first part of the write back operation, the current flowing through the reference cell RCp is relatively low (L). Thereafter, the data of the reference cell RCp is rewritten into data “0”, and so, during the second part of the write back operation, the current flowing through the reference cell RCp is relatively high (H).

Under the conditions described above, the results of a current value are a value (L+L+L) during the first part of the write back operation (tA-tB) and a value (L+H+L) during the second part of the write back operation (tC-tD).

As regards the current value obtained when data “1” is written back into the memory cell MC, there are various examples other than the examples shown in FIGS. 6A and 6B. Thus, the value of a current that flows during the first part of the write back operation varies. However, the value of a current that flows during the second part of the write back operation, i.e., when the respective cells MC, RCp, and RCap have been written back with correct data, is a value (L+H+L) in any case.

In FIGS. 5A to 6B described above, the supplies of write back currents to the write back target cells MC, RCp, and RCap are started and stopped at almost the same time and so their write back periods overlap one another almost completely, but this is not limiting. The write back periods of the respective cells MC, RCp, and RCap may be shifted from one another. However, as described above, the write back operations to the respective cells MC, RCp, and RCap are preferably performed in parallel with one another. The term “in parallel with one another” means that the write back periods of the respective cells MC, RCp, and RCap partly or entirely overlap one another. This makes it possible to shorten the write back period as a whole.

As described above, when data write back is performed to the memory cell MC, write back is also performed to one or more sets of reference cells RCp and RCap. Accordingly, the memory cell MC is not subjected to write back alone. In other words, when data write back is performed to the memory cell MC, currents flow not only through a memory circuit Cm (Cm1, Cm2 . . . ) shown in FIG. 1 described above but also through a reference circuit Cr (Cr1, Cr2 . . . ).

Thus, even in a case where any data is written back into the memory cell MC, and even in a case where any number of memory cells are considered as data write back targets, the value of a current that flows when data write back has been performed to the memory cell MC is higher than either of the values Ip and Iap of a current that flows when data of one bit has been written into the MTJ element R.

Further, as described above with reference to FIGS. 6A and 6B, the value (L+H+L) of a current that flows when write back with data “1” has been performed to one memory cell MC corresponds to the total value of the value of current (Ip×1) that flows when data of one bit in the low resistance state has been written into the MTJ element R and the value of current (Iap×2) that flows when data of two bits in the high resistance state has been written into the MTJ element R.

The total value described above is the lower limit value of a current that flows when data write back has been performed to the memory cell MC. Thus, even in a case where any data is written back into the memory cell MC, and even in a case where any number of memory cells are considered as data write back targets, the lower limit value of a current that flows when data write back has been performed to the memory cell MC is not lower than the total value described above.

More specifically, in a case where the write back target memory cell MC is single, the correct data of this memory cell MC is data “1”, and write back is performed to both of the one set of reference cells RCp and RCap, the value of a current flowing is equal to the total value described above. In any case other than this case, the value of a current flowing is higher than the total value described above. For example, as in the example shown in FIGS. 5A and 5B described above, the value of a current that flows when the correct data of the write back target memory cell MC is data “0” corresponds to the total value of the value of a current (Ip×2) that flows when data of two bits in the low resistance state has been written into the memory cell MC and the value of current (Iap×1) that flows when data of one bit in the high resistance state has been written into the memory cell MC. This total value is higher than the total value described above obtained when the correct data of the memory cell MC is data “1”. Other than this, for example, when the write back target memory cells MC are two or more, or when write back is performed to two or more sets of reference cells RCp and RCap, the value of a current flowing is higher than the total value described above.

Further, when write back is performed to one memory cell MC along with one or more sets, such as “n”-sets, of reference cells RCp and RCap, the value of current Iwb that flows when data of one bit of the MTJ element R has been written back is expressed by either one of the following formulas (1) and (2). Further, in this case, it is assumed that “m”-sets of reference cells RCp and RCap are configured to be referred to for the memory cell MC described above, where each of “n” and “m” is an integer of 1 or more, and “n” is not larger than “m” (n≦m).

Iwb=Ip+(Ip+Iap)×n (1)

Iwb=Iap+(Ip+Iap)×n (2)

The formula (1) expresses the value of current Iwb that flows when the correct data of the write back target MTJ element R is in the low resistance state. The formula (2) expresses the value of current Iwb that flows when the correct data of the write back target MTJ element R is in the high resistance state.

(5) Effects Provided by this Embodiment:

This embodiment provides one or more effects, as described below.

(A) According to this embodiment, if an error is detected about the data of a memory cell MC, the control circuit 300 performs write back to the data of the memory cell MC associated with the error detected and the data of the reference cells RCp and RCap, in parallel with one another. Consequently, even when an error has been generated in the reference cells RCp and RCap, data write correction can be performed.

As described above, data held in memory cells may include an error caused in the data write period of the memory cells or caused thereafter by a change made with time or suddenly. Accordingly, for example, error determination is performed to data read from memory cells, and write back with correct data is performed to memory cells associated with errors detected. However, even if error correction is performed to the memory cells, there may be a case where the number of memory cells determined as being erroneous and/or faulty is increased with time.

The present inventors assumed that such deterioration in the error rate and/or the failure rate was caused by reference cells. For example, the data of each reference cell is held by an MTJ element having a configuration similar to that of the MTJ element of each memory cell. Accordingly, the data held by the MTJ element used for the reference cell may also be rewritten and altered by a change made with time or suddenly. The present inventors assumed that an error could be detected about the data of a memory cell not only in a case where an error was generated in the data of the memory cell but also in a case where an error was generated in the data of a reference cell. Under the circumstances, even if write back was repeated only to memory cells, errors could be accumulated in reference cells, thereby deteriorating the error rate and/or the failure rate of the MRAM.

According to this embodiment, when data write back is performed to a memory cell MC, data write back is also performed to reference cells RCp and RCap. Consequently, the failure rate of the MRAM 10 caused by the reference cells RCp and RCap is reduced.

(B) According to the configuration (A) described above, write back can be performed to the reference cells RCp and RCap without excessive operations performed by the control circuit 300, the ECC circuit 320, and so forth. Since the data supposed to be held by the reference cells RCp and RCap is fixed, the data to be written back into the reference cells RCp and RCap is predetermined. Accordingly, for example, when write back is performed to the reference cells RCp and RCap, there is no need to perform error detection to the reference cells RCp and RCap. Further, there is no need to hold, in advance, information of data to be written back.

(C) According to this embodiment, the reference cells RCp and RCap to which the write back is performed are reference cells RCp and RCap that are at least part of reference cells RCp and RCap configured to be referred to when data of the memory cell MC is read.

Thus, according to this embodiment, write back is performed only to those selected from the reference cells RCp and RCap configured to be referred to for the memory cell MC associated with a detected error, and write back is not performed to the other reference cells RCp and RCap. Consequently, the power consumption necessary for write back is reduced. Thus, the power supply voltage can be lowered, and so the write power supply PSw can be downsized.

(D) According to the configuration (C) described above, in a case where data of a memory cell MC is read while reference currents are generated by a plurality of sets of reference cells RCp and RCap, the control circuit 300 can perform write back only to part of the sets of reference cells RCp and RCap. Consequently, the power consumption necessary for write back is reduced.

(E) According to this embodiment, the reference cells RCp and RCap to which the write back is performed include a reference cells RCp and RCap connected, through a shortest current path, to the memory cell MC associated with the error detected, which is part of reference cells RCp and RCap configured to be referred to when data of the memory cell MC is read.

When the detected error is caused by reference cells RCp and RCap, there is a high probability that, of a plurality of sets of reference cells RCp and RCap, an error has been caused in the reference cells RCp and RCap connected, through a short wiring line, to the memory cell MC associated with the detected error. This is because cells MC, RCp, and RCap connected to one another through short wiring lines are apt to easily receive mutual influences, such as resistance.

According to this embodiment, data correction can be performed to reference cells RCp and RCap having a high probability of error generation, while the power consumption necessary for write back is reduced.

(F) According to this embodiment, if an error is detected about the data of a data bit discriminated by comparing the data of the data bit with the data of a reference bit, the control circuit 300 performs write back to the data of the data bit associated with the error detected and the data of the reference bit, in parallel with one another. Consequently, data write correction can be performed even when an error has been generated in the reference bit, and so the failure rate of the MRAM 10 caused by the reference bit can be reduced.

Further, write back current values described in the following (G) to (J) indicate that not only the memory cell MC associated with the detected error but also the reference cells RCp and RCap have been written back. Since the reference cells RCp and RCap are written back, the failure rate of the MRAM 10 caused by the reference cells RCp and RCap can be reduced.

(G) According to this embodiment, the value of a current that flows during the second part of when write back is performed to data of an MTJ element R associated with an error detected is higher than the value of a current that flows during the second part of when data of one bit is written in the MTJ element R.

(H) According to this embodiment, the value of a current that flows during the second part of when write back is performed to data of an MTJ element R associated with an error detected is not lower than the total value of the value of a current that flows during the second part of when data of one bit in the low resistance state is written into the MTJ element R and the value of a current that flows during the second part of when data of two bits in the high resistance state is written into the MTJ element R.

(I) According to this embodiment, the value of current Iwb that flows during the second part of when write back is performed to data of an MTJ element R associated with an error detected is expressed by either one of the formulas (1) and (2) described above.

(J) According to this embodiment, when write back is performed to data of an MTJ element R, a current also flows through a reference circuit Cr.

(6) Modification of Embodiment:

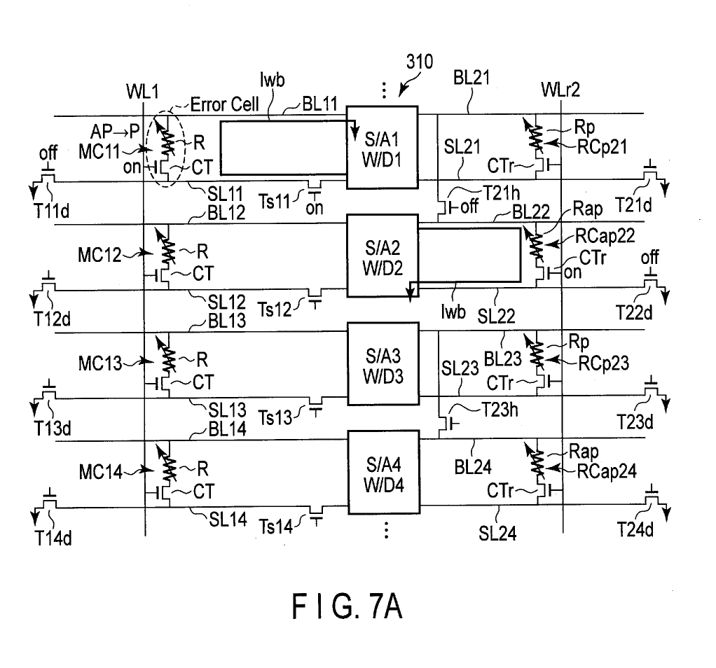

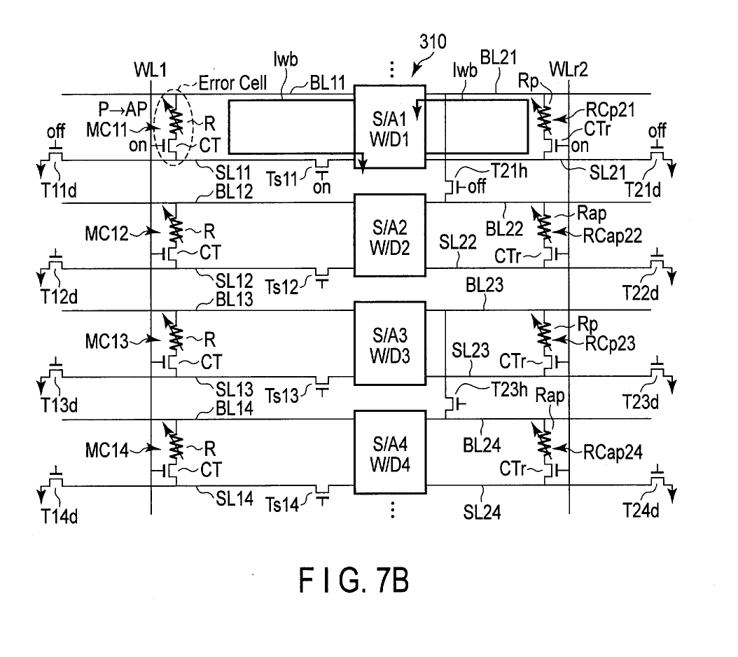

An explanation will be given of a modification according to this embodiment, with reference to FIGS. 7A, 7B, 8A, 8B, 9A, and 9B. This modification differs from the embodiment described above in that, for example, write back is performed to only either one of a set of reference cells RCp and RCap.

[Write Back Operation]

FIGS. 7A and 7B show a write back operation of the resistance change memory device according to a modification of this embodiment. The operation described below is mainly performed by the RW circuit 310 and the ECC circuit 320 in accordance with control of the control circuit 300, which has received an instruction from outside. In this modification, the control circuit 300 determines a reference cell RCp or RCap to be written back, from one set of reference cells RCp and RCap, based on the data of a memory cell MC associated with a detected error.

Specifically, as shown in FIGS. 7A and 7B, the control circuit 300 performs write back to the reference cell RCp or reference cell RCap, which has data different from the correct data of the memory cell MC associated with the detected error, of the one set of reference cells RCp and RCap. More specifically, if the correct data of the memory cell MC is data “0”, the control circuit 300 performs write back to the reference cell RCap whose original data is data “1”. If the correct data of the memory cell MC is data “1”, the control circuit 300 performs write back to the reference cell RCp whose original data is data “0”. For example, this write back is performed to the reference cell RCp or reference cell RCap in parallel with write back performed to the memory cell MC.

FIG. 7A shows an example of a write back operation to reset error data (“1”) held in the memory cell MC11 to correct data (“0”) when the memory cell MC11 is considered as an error cell associated with a detected error, i.e., as a write back target cell. In other words, the MTJ element R in the anti-parallel state (“AP”) is changed into the parallel state (“P”) by this write back. As shown in FIG. 7A, this write back operation is performed in the same way as the write back operation performed to the memory cell MC11 shown in FIG. 4A described above.

Further, at this time, write back is performed to the reference cell RCap22 of the reference cells RCp21 and RCap22 configured to be referred to when the data of the memory cell MC11 is read. As shown in FIG. 7A, this write back operation is performed in the same way as the write back operation performed to the reference cell RCap22 shown in FIG. 4A described above.

FIG. 7B shows an example of a write back operation to reset error data (“0”) held in the memory cell MC11 to correct data (“1”) when the memory cell MC11 is considered as an error cell associated with a detected error, i.e., as a write back target cell. In other words, the MTJ element R in the parallel state (“P”) is changed into the anti-parallel state (“AP”) by this write back. As shown in FIG. 7B, this write back operation is performed in the same way as the write operation performed to the memory cell MC11 shown in FIG. 4B described above.

Further, at this time, write back is performed to the reference cell RCp21 of the reference cells RCp21 and RCap22 configured to be referred to when the data of the memory cell MC11 is read. As shown in FIG. 7B, this write back operation is performed in the same way as the write back operation performed to the reference cell RCp21 shown in FIG. 4B described above.

Also in this modification, it may be designed such that a plurality of sets of reference cells RCp and RCap are used to generate reference currents when the data of one memory cell MC is read. In this case, when write back is performed to the memory cell MC, write back may be performed to one reference cell RCp or RCap of at least one set of reference cells RCp and RCap, selected from the plurality of sets of reference cells RCp and RCap. Alternatively, write back may be performed to one reference cell RCp or RCap of several sets of reference cells RCp and RCap or all the sets of reference cells RCp and RCap.

However, when write back is performed to one of the reference cells RCp and RCap in part of the plurality of sets of reference cells RCp and RCap, one of the reference cells RCp and RCap connected to the write back target memory cell MC through the shortest current path is preferably included in the write back targets. For example, in terms of the physical arrangement, it is preferable that the write back targets preferentially include one of the reference cells RCp and RCap positioned opposite to the memory cell MC with the sense amplifier SA interposed therebetween. Alternatively, it is preferable that the write back targets include one of the reference cells RCp and RCap positioned closest to the memory cell MC, one of reference cells RCp and RCap positioned adjacent to them, and one of reference cells RCp and RCap positioned around them.

[Current Value in Resistance Change Memory Device]

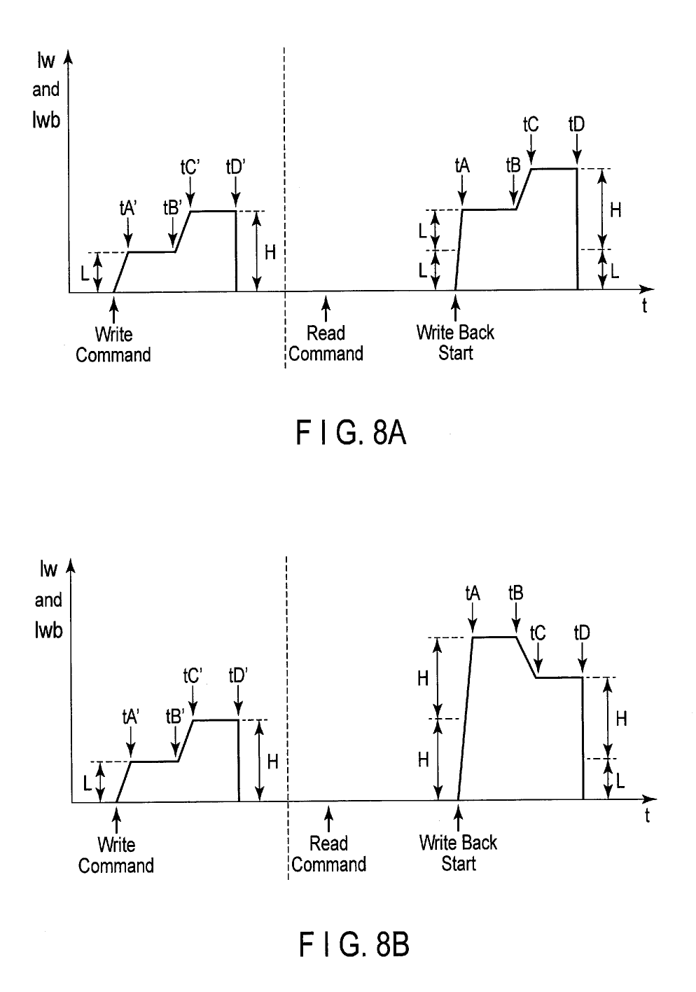

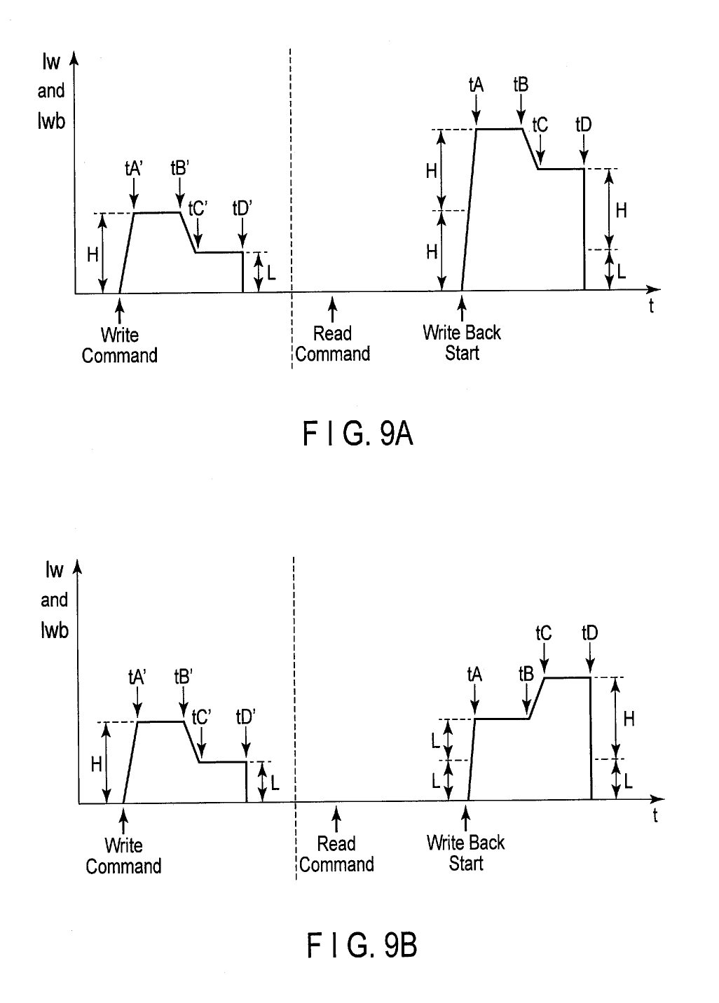

FIGS. 8A to 9B show examples of the value of a current flowing through the resistance change memory device according to the modification of this embodiment.

Particularly, as regards the write back operation, FIGS. 8A to 9B respectively show examples of current values obtained in a case where there is one operation target memory cell MC and this memory cell MC is written back with data “0” or “1”, and when an error has been caused in the data of the memory cell MC or an error has been caused in the data of a reference cell.

(Write Back with Data “0” to Memory Cell)

FIGS. 8A and 8B show examples of a current supplied to the write driver WD in the write operation, the read operation, and the write back operation in a case where one memory cell MC is written with data “0”.

As shown in FIGS. 8A and 8B, when data “0” is written into one memory cell MC, the current value in this write operation is equal to the value of a current that flows during the write operation shown in FIGS. 5A and 5B described above.

When data is read from the one memory cell MC described above, the write power supply PSw does not supply any current, and so the current value in FIGS. 8A and 8B is kept at zero.

If an error is detected about the data read from the one memory cell MC described above, the control circuit 300 starts the write back operation by use of the write driver WD.

FIG. 8A shows an example where the memory cell MC holds error data (“1”) while the reference cell RCap holds correct data (“1”).

The memory cell MC holds data “1” at first.

Accordingly, during the first part of the write back operation (tA-tB), the current flowing through the memory cell MC is relatively low (L). Thereafter, the data of the memory cell MC is rewritten into data “0”, and so, during the second part of the write back operation (tC-tD), the current flowing through the memory cell MC is relatively high (H).

The reference cell RCap holds data “1” from the beginning, and further keeps data “1” thereafter. Accordingly, during both of the first part and the second part of the write back operation, the current flowing through the reference cell RCap is kept relatively low (L).

Under the conditions described above, the results of a current value are a value (L+L) during the first part of the write back operation (tA-tB) and a value (H+L) during the second part of the write back operation (tC-tD).

FIG. 8B shows an example where the memory cell MC holds correct data (“0”) while the reference cell RCap holds error data (“0”).

The memory cell MC holds data “0” from the beginning, and further keeps data “0” thereafter. Accordingly, during both of the first part (tA-tB) and the second part (tC-tD) of the write back operation, the current flowing through the memory cell MC is kept relatively high (H).

The reference cell RCap holds data “0” at first. Accordingly, during the first part of the write back operation, the current flowing through the reference cell RCap is relatively high (H). Thereafter, the data of the reference cell RCap is rewritten into data “1”, and so, during the second part of the write back operation, the current flowing through the reference cell RCap is relatively low (L).

Under the conditions described above, the results of a current value are a value (H+H) during the first part of the write back operation (tA-tB) and a value (H+L) during the second part of the write back operation (tC-tD).

(Write Back with Data “1” to Memory Cell)

FIGS. 9A and 9B show examples of a current supplied to the write driver WD in the write operation, the read operation, and the write back operation in a case where one memory cell MC is written with data “1”.

As shown in FIGS. 9A and 9B, when data “1” is written into one memory cell MC, the current value in this write operation is equal to the value of a current that flows during the write operation shown in FIGS. 6A and 6B described above.

When data is read from the one memory cell MC described above, the write power supply PSw does not supply any current, and so the current value in FIGS. 9A and 9B is kept at zero.

If an error is detected about the data read from the one memory cell MC described above, the control circuit 300 starts the write back operation by use of the write driver WD.

FIG. 9A shows an example where the memory cell MC holds error data (“0”) while the reference cell RCp holds correct data (“0”).

The memory cell MC holds data “0” at first. Accordingly, during the first part of the write back operation (tA-tB), the current flowing through the memory cell MC is relatively high (H). Thereafter, the data of the memory cell MC is rewritten into data “1”, and so, during the second part of the write back operation (tC-tD), the current flowing through the memory cell MC is relatively low (L).

The reference cell RCp holds data “0” from the beginning, and further keeps data “0” thereafter. Accordingly, during both of the first part and the second part of the write back operation, the current flowing through the reference cell RCp is kept relatively high (H).

Under the conditions described above, the results of a current value are a value (H+H) during the first part of the write back operation (tA-tB) and a value (H+L) during the second part of the write back operation (tC-tD).

FIG. 9B shows an example where the memory cell MC holds correct data (“1”) while the reference cell RCp holds error data (“1”).

The memory cell MC holds data “1” from the beginning, and further keeps data “1” thereafter. Accordingly, during both of the first part (tA-tB) and the second part (tC-tD) of the write back operation, the current flowing through the memory cell MC is kept relatively low (L).

The reference cell RCp holds data “1” at first. Accordingly, during the first part of the write back operation, the current flowing through the reference cell RCp is relatively low (L). Thereafter, the data of the reference cell RCp is rewritten into data “0”, and so, during the second part of the write back operation, the current flowing through the reference cell RCp is relatively high (H).

Under the conditions described above, the results of a current value are a value (L+L) during the first part of the write back operation (tA-tB) and a value (H+L) during the second part of the write back operation (tC-tD).

In FIGS. 8A to 9B described above, the write back periods of the respective cells MC, RCp, and RCap may be shifted from one another. However, the write back operations to the respective cells MC, RCp, and RCap are preferably performed in parallel with one another. The term “in parallel with one another” means that the write back periods of the respective cells MC, RCp, and RCap partly or entirely overlap one another.

As regards the current value obtained when data “0” or “1” is written back into the memory cell MC, there are various examples other than the examples shown in FIGS. 8A to 9B. Thus, the value of a current that flows during the first part of the write back operation varies. However, the value of a current that flows during the second part of the write back operation, i.e., when the respective cells MC and RCp, or the respective cells MC and RCap have been written back with correct data, is (H+L) in any case. This current value corresponds to the total value of the value of current Ip that flows when data of one bit in the low resistance state has been written into the MTJ element R and the value of current Iap that flows when data of one bit in the high resistance state has been written into the MTJ element R.

In this modification, the total value described above is the lower limit value of a current that flows when data write back has been performed to the memory cell MC. Thus, even in a case where any data is written back into the memory cell MC, and even in a case where any number of memory cells are considered as data write back targets, the lower limit value of a current that flows when data write back has been performed to the memory cell MC is not lower than the total value described above.

Further, when write back is performed to one memory cell MC along with a reference cell RCp of RCap, or reference cells RCp of RCap selected from one or more sets, such as “n”-sets, of reference cells RCp and RCap, the value of current Iwb that flows when data of one bit of the MTJ element R has been written back is expressed by either one of the following formulas (3) and (4). Further, in this case, it is assumed that “m”-sets of reference cells RCp and RCap are configured to be referred to for the memory cell MC described above, where each of “n” and “m” is an integer of 1 or more, and “n” is not larger than “m” (n≦m).

Iwb=Ip+Iap×n (3)

Iwb=Iap+Ip×n (4)

The formula (3) expresses the value of current Iwb that flows when the correct data of the write back target MTJ element R is in the low resistance state. The formula (4) expresses the value of current Iwb that flows when the correct data of the write back target MTJ element R is in the high resistance state.

[Effects Provided by this Modification]

This modification provides one or more effects, as described below, in addition to the effects provided by the embodiment described above.

(A) According to this modification, a reference cell RCp or reference cell RCap to which the write back is performed is determined based on the data of a memory cell MC associated with an error detected. More specifically, the reference cell RCp or reference cell RCap to which the write back is performed is determined from reference cells RCp and RCap having data different from the correct data of the memory cell MC associated with the error detected.

When the data of the memory cell is determined as an error because an error has been generated in the reference cell RCp or reference cell RCap, there is a high probability that the error has been generated in a reference cell RC holding data opposite to the correct data of the memory cell MC.

In a case where correct data “0” is held in the memory cell MC but it is determined that the memory cell is associated with an error, it is likely that the value of a reference current generated by the reference cells RCp and RCap is higher than usual. The resistance value of the MTJ element Rp included in the reference cell RCp is almost equal to the lowest value of the resistance value as an MTJ element. Accordingly, it is unlikely that the MTJ element Rp has come into a lower resistance state beyond the usual range and thereby made the reference current higher. Thus, in this case, there is a high probability that the MTJ element Rap included in the reference cell RCap has come into a lower resistance state (for example, a state equal to the resistance value of the MTJ element Rp).

In a case where correct data “1” is held in the memory cell MC but it is determined that the memory cell is associated with an error, it is likely that the value of a reference current generated by the reference cells RCp and RCap is lower than usual. The resistance value of the MTJ element Rap included in the reference cell RCap is almost equal to the highest value of the resistance value as an MTJ element. Accordingly, it is unlikely that the MTJ element Rap has come into a higher resistance state beyond the usual range and thereby made the reference current lower. Thus, in this case, there is a high probability that the MTJ element Rp included in the reference cell RCp has come into a higher resistance state (for example, a state equal to the resistance value of the MTJ element Rap).

According to this modification, write back is performed to the reference cell RCp or reference cell RCap, which has a high probability of error generation. In this way, write back is performed only to one of the reference cells RCp and RCap, and so the power consumption necessary for write back is reduced.

(B) According to this modification, the reference cell RCp or reference cells RCap to which the write back is performed is determined to include a reference cell RC connected, through the shortest current path, to a memory cell MC associated with an error detected, and selected from the reference cells RC having data different from the correct data of the memory cell MC associated with the error detected.

When an error is caused in any one of the reference cells RCp and RCap, there is a high probability that the error has been caused in any one of the reference cells RCp and RCap connected, through a short wiring line, to the memory cell MC associated with the detected error. According to this configuration, data correction can be performed to any one of the reference cells RCp and RCap which have a high probability of error generation, while the power consumption necessary for write back is reduced.

Further, write back current values described in the following (C) to (F) indicate that not only the memory cell MC associated with the detected error but also either one of the reference cells RCp and RCap has been written back. Since either one of the reference cells RCp and RCap is written back, the failure rate of the MRAM 10 caused by the reference cells RCp and RCap can be reduced.

(C) According to this modification, the value of a current that flows during the second part of when data write back is performed to an MTJ element R associated with an error detected is higher than the value of a current that flows during the second part of when data of one bit is written in the MTJ element R.

(D) According to this modification, the value of a current that flows during the second part of when write back is performed to data of an MTJ element R associated with an error detected is not lower than the total value of the value of a current that flows during the second part of when data of one bit in the low resistance state is written into the MTJ element R and the value of a current that flows during the second part of when data of one bit in the high resistance state is written into the MTJ element R.

(E) According to this modification, the value of current Iwb that flows during the second part of when write back is performed to data of an MTJ element R associated with an error detected is expressed by either one of the formulas (3) and (4) described above.

(F) According to this modification, when write back is performed to data of an MTJ element R, a current also flows through a reference circuit Cr.

### Other Embodiments

The embodiment and the modification described above are based on an example where write back is performed to one or more of the reference cells RCp and RCap configured to generate a reference current or reference currents for a memory cell MC when the data of the memory cell MC is read, but this is not limiting. Write back may be performed to one or more of reference cells RCp and RCap other than the reference cells RCp and RCap configured to be referred to when the data of the memory cell MC is read.

The embodiment and the modification described above are explained by an example where, when data write back is performed to a memory cell MC, write back is also performed to reference cells RCp and RCap at this time, but this is not limiting. Write-back of a reference cell may be performed only once in a plurality of times when write back of a memory cell is performed, or it may be performed at regular intervals or at irregular intervals after a lapse of a specific time.

The embodiment and the modification described above are explained by an example where the MRAM 10 includes the write power supply PSw and the read power supply PSr, but this is not limiting. The MRAM may include a common power supply for supplying the write current, the write back current, and the read current.

The embodiment and the modification described above are based on an example where data is discriminated by a difference in current value, which is assumed from a difference in resistance value based on the states of MTJ elements R, but this is not limiting. Data may be discriminated by a difference in voltage value, which is assumed from a difference in resistance value of MTJ elements R.

The embodiment and the modification described above are based on an example where the MTJ element R shown in FIG. 2 is employed as a memory element, but this is not limiting. An MTJ element to be employed may be a perpendicular magnetization MTJ element having perpendicular magnetic anisotropy, or may be a horizontal magnetization MTJ element having horizontal magnetic anisotropy. Further, an MTJ element to be employed may be a top free type (bottom pinned type) MTJ element in which a recording layer is arranged above a fixed layer, or may be a bottom free type (top pinned type) MTJ element in which a recording layer is arranged below a fixed layer. In this case, an MTJ element to be employed for a reference cell may be configured in the same way.

The embodiment and the modification described above are explained by an example where the resistance change memory device is the MRAM 10 that employs MTJ elements R as memory elements, but this is not limiting. For example, the resistance change memory device may be a ReRAM (Resistive Random Access Memory), PRAM, or PCRAM (Phase Change Random Access Memory).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the invention.

What is claimed is:

1. A resistance change memory device comprising:
memory cells each including a resistance change element,
reference cells each including a resistance change element, and
a control circuit configured to control the memory cells and the reference cells,
wherein, if an error is detected about data of a memory cell,
the control circuit performs write back to data of the memory cell associated with the error detected and data of a reference cell in parallel with one another.

2. The resistance change memory device according to claim 1, wherein the reference cell to which the write back is performed is a reference cell that is at least part of reference cells configured to be referred to when data of the memory cell is read.

3. The resistance change memory device according to claim 1, wherein the reference cell to which the write back is performed includes a reference cell connected, through a shortest current path, to the memory cell associated with the error detected, which is part of reference cells configured to be referred to when data of the memory cell is read.

4. The resistance change memory device according to claim 1, wherein the reference cell to which the write back is performed is determined from reference cells configured to be referred to when data of the memory cell is read, based on data of the memory cell associated with the error detected.

5. The resistance change memory device according to claim 1, wherein the reference cell to which the write back is performed is determined from reference cells having data different from correct data of the memory cell associated with the error detected, which is part of reference cells configured to be referred to when data of the memory cell is read.

6. The resistance change memory device according to claim 1, wherein the reference cell to which the write back is performed is determined to include a reference cell connected, through a shortest current path, to the memory cell associated with the error detected, and selected from reference cells having data different from correct data of the memory cell associated with the error detected, which is part of reference cells configured to be referred to when data of the memory cell is read.

7. The resistance change memory device according to claim 1, wherein each of the memory cells is configured to take a low resistance state and a high resistance state.

8. The resistance change memory device according to claim 1, wherein
each of the reference cells takes either one of a low resistance state and a high resistance state, and
reference cells configured to be referred to when data of the memory cell is read include reference cells in the low resistance state and reference cells in the high resistance state, which are equal in number.

9. The resistance change memory device according to claim 1, wherein
each of the memory cells includes a magnetoresistive element, and
each of the reference cells includes a magnetoresistive element.

10. A resistance change memory device comprising:
a resistance change element, and
a control circuit,
wherein, if an error is detected about data of a data bit discriminated by comparing the data of the data bit with data of a reference bit,
the control circuit performs write back to data of the data bit associated with the error detected and data of the reference bit in parallel with one another.

11. A resistance change memory device configured to hold different data depending on whether resistance change elements are in a low resistance state or in a high resistance state,
wherein a value of a current that flows during the second part of when write back is performed to data of a resistance change element with an error detected is higher than a value of a current that flows during the second part of when data of one bit is written into the resistance change element.

12. The resistance change memory device according to claim 11, wherein the value of a current that flows during the second part of when write back is performed to data of a resistance change element with an error detected is not lower than a total value of a value of a current that flows during the second part of when data of one bit in the low resistance state is written into the resistance change element and a value of a current that flows during the second part of when data of two bits in the high resistance state is written into the resistance change element.

13. The resistance change memory device according to claim 11, wherein a value of current Iwb that flows during the second part of when write back with data of one bit is performed to a resistance change element with an error detected is equal to a value expressed by following formula (1) or (2), where Ip is a value of a current that flows during the second part of when data of one bit in the low resistance state is written into the resistance change element, Iap is a value of a current that flows during the second part of when data of one bit in the high resistance state is written into the resistance change element, and “n” is an integer of 1 or more.
Iwb=Ip+(Ip+Iap)×n (1)
Iwb=Iap+(Ip+Iap)×n (2)

14. The resistance change memory device according to claim 11, wherein the value of a current that flows during the second part of when write back is performed to data of a resistance change element with an error detected is not lower than a total value of a value of a current that flows during the second part of when data of one bit in the low resistance state is written into the resistance change element and a value of a current that flows during the second part of when data of one bit in the high resistance state is written into the resistance change element.

15. The resistance change memory device according to claim 11, wherein a value of current Iwb that flows during the second part of when write back with data of one bit is performed to a resistance change element with an error detected is equal to a value expressed by a following formula (3) or (4), where Ip is a value of a current that flows during the second part of when data of one bit in the low resistance state is written into the resistance change element, Iap is a value of a current that flows during the second part of when data of one bit in the high resistance state is written into the resistance change element, and “n” is an integer of 1 or more.
Iwb=Ip+Iap×n (3)
Iwb=Iap+Ip×n (4)

16. The resistance change memory device according to claim 11, wherein each of the resistance change elements is a magnetoresistive element.

17. A resistance change memory device configured to discriminate data of a resistance change element by comparing the data of the resistance change element with data of a reference circuit,
wherein, when write back is performed to data of the resistance change element with an error detected, a current flows through the reference circuit.

18. The resistance change memory device according to claim 17, wherein the reference circuit includes a resistance change element.

19. The resistance change memory device according to claim 17, wherein the reference circuit includes a magnetoresistive element.

20. The resistance change memory device according to claim 17, wherein the reference circuit includes a resistance change element in a low resistance state and a resistance change element in a high resistance state, which are equal in number.
